(19) United States
(12) Patent Application Publication
(10) Pub. No.: US 2008/0083330 A1
(43) Pub. Date: Apr. 10, 2008

(54) Method for separation of molecular/atomic/ionic mixtures

(75) Inventors: Yashonath Subramanian, Bangalore (IN); Ananthakrishna Garani, Bangalore (IN); Anil Kumar Anil Nivas Vasudevan Nair, Bangalore (IN)

Correspondence Address: FOLEY AND LARDNER LLP;SUITE 500, 3000 K STREET NW, WASHINGTON, DC, 20007, US

(73) Assignee: The Registrar, Indian Institute Of Science

(21) Appl. No.: 11/902,788

(22) Filed: Sep. 25, 2007

Related U.S. Application Data
(63) Continuation-in-part of application No. 10/499,185, filed on Mar. 21, 2005, now abandoned.

(30) Foreign Application Priority Data
Dec. 18, 2001 (IN) 1006/MAS/2001

(51) Int. Cl. B01D 53/22; B03C 1/00

(52) U.S. Cl. 95/28; 95/43

(57) ABSTRACT

Disclosed herein is an improved method for the separation of molecular/atomic/ionic mixtures. An efficient process for separation of multicomponent mixtures (including binary mixtures) is the object of the invention. Both the levitation effect and blow-torch effect are used simultaneously for separation of mixtures achieve a high degree of separation using a relatively short length of a separation column comprising a porous solid selected to be appropriate for the mixture to be separated.

This application is a Continuation-In-Part of application Ser. No. 10/499,185, filed Dec. 18, 2002, which is incorporated herein by reference. The references cited in the specification of the parent application are also incorporated herein.

### FIELD OF THE INVENTION

This invention relates to an improved method of separation of molecular/atomic/ionic mixtures using a judicious combination of both “Levitation” and “Blow-torch” effects, to achieve very high factors of separation.

### BACKGROUND OF THE INVENTION

Mixtures of atoms or molecules which exist in nature often need to be separated for industrial and other purposes. In the chemical industry, separation of gases and vapours is carried out on a large commercial scale. In biology, protein isolation is important and necessary to the study of its properties. Separation of mixtures of molecules or atoms or ions can be achieved by a number of processes. Distillation, chromatography, adsorption, membrane-based separation, and crystallization are some of the conventional methods employed for separation [References 1-20]. All these methods can be classified under two types as follows:
(i) Equilibrium-based methods; and
(ii) Kinetics-based methods.

For example, in one of the well known equilibrium based methods, when a particular pressure is applied to the mixtures, one component of the mixture adsorbs/absorbs while the other does not for the same pressure and, thus, the components get separated.

Kinetics-based methods exploit the differences in the transport properties usually self-diffusivity or transport diffusivity of the components of a mixture to effect separation.

Separation is of great commercial importance. For example, crude oil needs to be separated into different streams each containing hydrocarbons of different sizes, CₙHₘ (1<n<20). Without such a separation, one cannot obtain air fuel, petrol, kerosene, diesel, tar etc. There are many other well-known industrial requirements for the separation of mixtures, such as those of N₂/O₂, linear and branched alkanes, benzene and its derivatives, saturated and unsaturated hydrocarbons (propane/propylene mixtures, ethane/ethylene mixture). The economic or financial cost can be very high when separation methods with lower efficiency are used, since these methods are used on millions of tons of mixtures every year.

In the known methods of separation (References 1-12), there exist several drawbacks. For example, distillation is highly energy intensive, relatively unsafe, and expensive. In known membrane-based separations, diffusion is sometimes slow, and a high degree of separation is not often obtained. The efficiency of separation achieved by any method may be quantified by the “separation factor” also known as “separation power” defined as:

$$\begin{matrix}α = ( mole ratio of A / B in extract ) / \\ ( mole ratio of A / B in raffinate ) \\ \frac{{c}_{1}^{a} / {c}_{1}^{b}}{{c}_{2}^{a} / {c}_{2}^{b}}\end{matrix} \qquad ( 1 )$$

where c is the measure of the composition such as mole fraction, concentration in moles, or mass per unit volume. Here, a and b are the two components of the mixture to be separated, and 1 and 2 are the two product streams after the separation. The extract is enriched with one of the two components, while the raffinate is enriched with the other component. The separation factor obtained depends on the method employed, and varies over a wide range for different processes. Many of these methods (References 1-20), are “passive”, in the sense that the separation occurs because of the difference in the transport properties, as in the case of kinetics-based separation methods. These are frequently slow due to low transport coefficients of the components and, therefore, expensive. In equilibrium-based separation methods involving adsorption/desorption, difficulties associated with complete evacuation during desorption often leads to degradation in the degree of separation. In separation by commonly used methods such as distillation, the energy cost is very high. One set of methods of relevance here is the separation of hydrocarbon mixtures using zeolites. These are extensively used in petrochemical refineries. In existing “active” separation processes, such as those driven by an external field or gradient, the driving force acts on both the components in the same way or direction, which leads, at best, to a reasonable but not excellent separation.

The object of this invention is to provide an alternate, active method, in which the two components of a binary mixture to be separated are driven in opposite directions in a separation column made of an appropriately chosen porous solid. By doing so, a very high degree of separation is achieved, as disclosed herein. The method is based on two principles, namely, the levitation effect [Reference 21] and the blow-torch effect [Reference 22]. The method will be illustrated by several examples. Each example demonstrates the separation of a specific mixture when passed through a column of a porous solid, namely, an appropriately selected zeolite.

Zeolites are porous solids made up of Al, Si, 0 and consist of interconnected networks of SiO₄ and AlO₄ tetrahedra. Zeolites also have small- and medium-sized interconnected pores of dimensions in the range of 1-20 Å, which can accommodate molecules such as those of hydrocarbons. In the usual separation methods, the molecular sieving property of the zeolites is commonly used in the separation of mixtures, wherein molecules of different sizes diffuse or pass through a zeolite separation column at different rates. The rates are determined by the self-diffusivities of the different molecules. Bigger molecules typically have lower self-diffusivities.

The dimensions of any molecular species are specified by a length, width, and height. The longest of the three dimensions is generally referred to as the length. The width and height are the other two dimensions transverse to the length. The dimensions of the molecules that are relevant for diffusion in a porous medium like zeolite (often called the host) are the width and the height. The length is not relevant as the molecule generally traverses parallel to its long molecular axis and therefore the width and height of the molecule determine whether it can pass through the “window” of the zeolite whose dimension is determined by the width and the height.

The Levitation effect refers to the anomaly in self-diffusivity that occurs in porous solids [Reference 21]. Self-diffusivity D exhibits a surprising nonlinear dependence on the “size” of the diffusing (also referred to as the guest) species. For instance, D exhibits a peak when the dimensions (width and height) of the guest species (diffusant) are comparable to the dimensions of the pore (defined by its width and height) in porous solids. However, for small dimensions of the diffusant or the guest, D exhibits the normally expected linear dependence on the inverse square of the ‘size’ (dimension) of the diffusant. In simulations of diffusion through a porous solid, the size (dimension) of the guest species is taken to be the Lennard-Jones parameter, σ_{gg}. Thus, for small σ_{gg}, D is linearly proportional to 1/σ_{gg}², as expected. This is called the linear regime. (See FIGS. 1, 2, and 3.) However, for larger σ_{gg}, D exhibits a pronounced peak, which is referred to as the anomalous or the Levitation regime (see FIGS. 1, 2, and 3) [Reference 21]. This behavior, called the Levitation effect, is observed in the simulation of diffusion through all types of porous solids, irrespective of the geometrical and topological details of the pore network [Reference 23].

To quantify the Levitation effect, a dimensionless parameter [Reference 21]

$$γ = \frac{{2}^{7 / 6} {σ}_{gh}}{{σ}_{gw}} \qquad ( 2 )$$

called the levitation parameter may be defined. Here, σ_{mw} is the window diameter and σ_{gh} is the guest-host Lennard-Jones interaction parameter. The dependence of self-diffusion coefficient D on the levitation parameter γ is shown in FIG. 3 for zeolite Y. The anomalous regime is seen when γ is close to unity, and the linear regime obtains for values of γ typically ranging up to 0.8 (see for example FIG. 3). However, the precise extents of the linear and anomalous regimes should be determined for each host-guest combination using molecular dynamics simulations, whose methodology is well known. The maximum in self-diffusivity, D, has its origin in the fortuitous cancellation of the dispersion forces on the guest (the diffusant) due to the host (FIG. 4). Such an unexpected cancellation of forces arising from the host porous medium occurs when the larger of the two dimensions (namely, the width and the height) of the guest is comparable to the window dimension of the host (see FIG. 4). Frictional forces on the guest are then the weakest, and this results in an increase in D. Under these conditions, the potential energy of the guest varies moderately with position in the pores (FIG. 6), with only small undulations [Reference 24]. The magnitude of the peak in D (as a function of γ or as a function of σ_{gg}, see FIGS. 1, 2, and 3) is dependent on the temperature and the degree of disorder in the void network [References 25, 26]. In order to realize the anomalous regime, a careful choice of the host porous solid for a given guest or a given mixture is therefore necessary. Generally, in most guest-host systems, γ is small and, hence, the linear regime prevails (FIG. 3). Given a porous solid like a zeolite, the plot of D versus γ or σ_{gg} is unique. When the dimensions of the molecule are smaller than the window dimensions of the zeolite, the potential energy has a minimum at cage centers and a maximum at the windows. In contrast, for molecules whose diameter is close to window diameter, the potential has its maxima located at the cage centers and minima at the windows (see FIG. 6).

Zeolites possess spatial and chemical inhomogeneities. The latter is evident in chemisorption in zeolites and is due to the presence of chemically reactive sites within the zeolites. Whenever reactions take place within zeolites, heat can be released or absorbed. Since zeolites are poor thermal conductors, this can lead to local hot or cold spots. The principle which deals with the effect of such hot regions on self-diffusivity is the Landauer blow-torch effect. The effect of an inhomogeneous temperature profile was originally treated by Landauer [Reference 22], and now goes by the name the ‘blow-torch’ effect. Briefly, Landauer showed that introduction of a “hot spot” between a lower lying minimum and the barrier maximum of a bistable potential can raise the population of the higher lying minimum relative to the lower lying minimum over and above that given by the Boltzmann factor (see below). Since the blow-torch effect is rather counter-intuitive, following Landauer [Reference 22], we illustrate the effect of a non-uniform temperature bath on the relative populations of competing local energy minima for a bistable potential U(x). For an overdamped particle in the potential U(x) shown by the curve ABCD in FIG. 5, subject to a uniform temperature T₀ along the coordinate, the probability of finding a particle at x is P(x)˜exp(−U(x)/k_{B}T₀). Clearly, the probability at A is higher than that at D. If the temperature of the region BC is now raised to T_{b}, the probability P(x)˜exp(−U(x))/k_{B}T_{b}) in BC, is clearly much smaller than the probability P(x) at the lower temperature T=T₀. If now only P(x) is given, then the corresponding ‘effective potential’ that determines this P(x) is obtained by inverting the original expression for P(x) and regarding the ‘potential’ to be given by U(x)/k_{B}T=−lnP(x). Thus, on raising the temperature to T_{b}, the decrease in P(x) in BC implies ln(P(x) is flatter in BC. This is equivalent to modifying the ‘potential’ to a flatter curve BC′ Since the probability P(x) is unaffected in other regions, the curve outside the region BC will be the same, except that the curve CD would start at C′ and end at D′ such that U(x_{C})−U(x_{D})=U(x_{C′})−U(x_{D′}). Thus, the minimum at D is brought down relative to A. Consequently, the probability, P(x_{D}), at x_{D}, is higher than the probability at the lower minimum x_{A}. Thus, the presence of a hot spot located between the potential minimum (A in FIG. 5) and the potential maximum (C in FIG. 5) enhances the escape rate over the barrier maximum (C in FIG. 4).

Recently, kinetic aspects of the blow-torch effect have been studied by one of the present inventors [Reference 27] for an idealized situation. More recently, a practical realization of the blow-torch effect has been demonstrated in the case of a zeolite by the present inventors [Reference 28].

Based on their understanding of the levitation and blow-torch effects, the present inventors recognized that a judicious combination of the levitation and blow-torch effects would lead to an efficient method for the separation of mixtures.

### OBJECTIVES OF THE INVENTION

It is the primary object of the invention to provide an improved method wherein the levitation and the blow-torch effects are used in combination for the separation of molecular/atomic/ionic mixtures.

It is another object of the invention to provide an improved method for the separation of molecular/atomic/ionic mixtures, which is economical in process and efficient in operation, and a substitute for traditional equilibrium-based and kinetics-based methods. Yet another object of the invention is to provide an improved method for the separation of mixtures, with a lower energy cost and a higher efficiency than existing methods. Further objectives of the invention will be clear from the following description.

### BRIEF DESCRIPTION OF THE ACCOMPANYING DRAWINGS

FIG. 1 shows the Levitation effect, through a D versus 1/σ_{gg}² plot, indicating the linear and anomalous regimes. The linear regime is the regime beyond the minimum and the anomalous regime ranges up to the minimum.

FIG. 2: A plot of the self-diffusion coefficient D as a function of 1/σ_{gg}² showing the anomalous regime (AR) and the linear regime (LR) for NaY zeolite.

FIG. 3: A plot of self-diffusion coefficient D as a function of γ for the zeolite NaY. Here, the linear regime extends up to the first minimum. The anomalous regime spans the region beyond the minimum. Note that the peak occurs at γ=1.

FIG. 4: Shows the twelve-membered ring of the zeolite NaY, along with two guests molecules of different sizes. The larger molecule experiences little force due to the zeolite in the plane of the window.

FIG. 5: Shows the effect of a hot zone on the relative populations in the two potential energy minima. The population in the higher potential minimum at D is increased to a value higher than that seen in A in the presence of a hot spot between B and C of the curve.

FIG. 6: Shows two cages of zeolite NaCaA with the location of the physisorption sites (filled circles). Note that additional cages are present along the two directions. The potential energy variation along the z-direction for particles in the (a) linear (small molecule) and (b) anomalous regime (large molecule of dimension similar to the window of the zeolite) are shown. The location of the hot zone is indicated by dashed vertical lines.

FIG. 7: Shows variation in density along the z-direction of two components in the mixture LR (see text) where both the components are from the linear regime. Also shown is the variation of the ratio log [n₁(z)/n₂(z)] along the z-direction.

FIG. 8: Shows variation in density along z-direction for the mixture consisting of an anomalous regime component and a linear regime component (AR, see text) and the ratio log (n₁(z)/n₂(z)). A straight line fit to log (n₁(z)/n₂(z)) has been used to obtain parameters in equation (4).

FIG. 9: Shows variation in density along z-direction for the component Ar and Ne in a Ne—Ar mixture, and the ratio log (n_{Ar}(z)/n_{Ne}(z)). A straight line fit to log (n_{Ar}(z)/n_{Ne}(z)) has been used to obtain parameters in equation (4).

### A SUMMARY OF THE PRESENT INVENTION

The present invention herein provides an improved method for the separation of molecular/atomic/ionic mixtures. More particularly, the improved method provides separation of mixtures of atomic, molecular, or ionic species of differing dimensions, the method involves the steps of passing the mixture through a column of a predetermined porous solid and simultaneously subjecting the mixture to the combined influence of “levitation” and “blow-torch” effects. Efficient processes for separation of multicomponent mixtures including binary mixtures are separated using the method of the instant invention. Both the levitation effect and blow-torch effect are used simultaneously for separation of mixtures to achieve a high degree of separation using a relatively short length of a separation column comprising a porous solid selected to be appropriate for the mixture to be separated.

### A DETAILED DESCRIPTION OF THE PRESENT INVENTION

The present invention is in relation to an improved method for the separation of mixtures of atomic, molecular, or ionic species of differing dimensions, said method comprising the steps of passing the mixture through a column of a predetermined porous solid and simultaneously subjecting the mixture to the combined influence of “levitation” and “blow-torch” effects.

In another embodiment of the present invention, wherein the mixture comprises various gases and vapours including, but not limited to, hydrocarbons, inert gases, hydrides, sulphides, and halides.

In yet another embodiment of the present invention, wherein the mixture is a binary mixture selected from a group comprising hydrocarbon gases, biological substances, ionic solutions, proteins, or combinations thereof.

In still another embodiment of the present invention, wherein the porous solid is selected so that one of the components of the binary mixture lies in the anomalous regime and the other in linear regime of diffusion through the porous solid, as defined by the value of γ, the levitation parameter.

In still another embodiment of the present invention, wherein the component of the binary mixture with γ closer to unity, lying in the anomalous regime is driven to one extreme of the separation column, and the other component with γ farther from, and significantly less than unity, lying in the linear regime is driven to the opposite extreme of the separation column.

In still another embodiment of the present invention, wherein the blow-torch effect is realized through the creation of hot spots at periodic locations in the predetermined porous solid.

In still another embodiment of the present invention, wherein the porous solid is a natural or a synthetic zeolite.

In still another embodiment of the present invention, wherein the hot spots are created (a) by attaching appropriate chemical groups at the desired periodic locations of the porous solid and (b) by the subsequent irradiation of the porous solid with electromagnetic radiation of a chosen range of wavelengths to induce resonant absorption of energy by the chemical groups so attached.

In still another embodiment of the present invention, wherein the hot spots are induced in porous solids at periodic locations along the direction in which the separation is to be achieved.

In still another embodiment of the present invention, wherein the electromagnetic radiation is preferably an infrared beam of frequency about 1600 cm⁻¹, which excites vibrational modes of the chemical group C═CH₂.

In still another embodiment of the present invention, wherein said chemical groups possessing a dipole moment, such as, but not limited to, —OH, —CN, —CF, —C═CH₂, are bonded to the pore structure of the porous solid.

In still another embodiment of the present invention, wherein the said chemical groups possessing a dipole moment, such as —OH, —CN, —CF, are bonded to the framework of a zeolite between cage centre and window at a distance ranging from 1 Å to 2 Å away from the plane of window.

In still another embodiment of the present invention, wherein the length of the column of the porous solid ranges from a few nanometers to a few millimeters. In still another embodiment of the present invention, wherein the column length of the porous solid is chosen to yield the degree of separation desired.

In still another embodiment of the present invention, wherein the mixtures of more than two components are separated through multiple iterations.

It is necessary to provide first a brief account of the conceptual foundations of the present invention for the separation of mixtures. The method judiciously combines two effects: (i) the levitation effect and (ii) ‘blow torch’ effect. The result of this is to drive the two components of a binary mixture in opposite directions, leading superior separation. The provision of such a driving force is what distinguishes the present invention from existing methods of separation.

In the interest of clarity, some aspects of the description of the levitation and blow-torch effects provided in the “Background” section above will be repeated in this section.

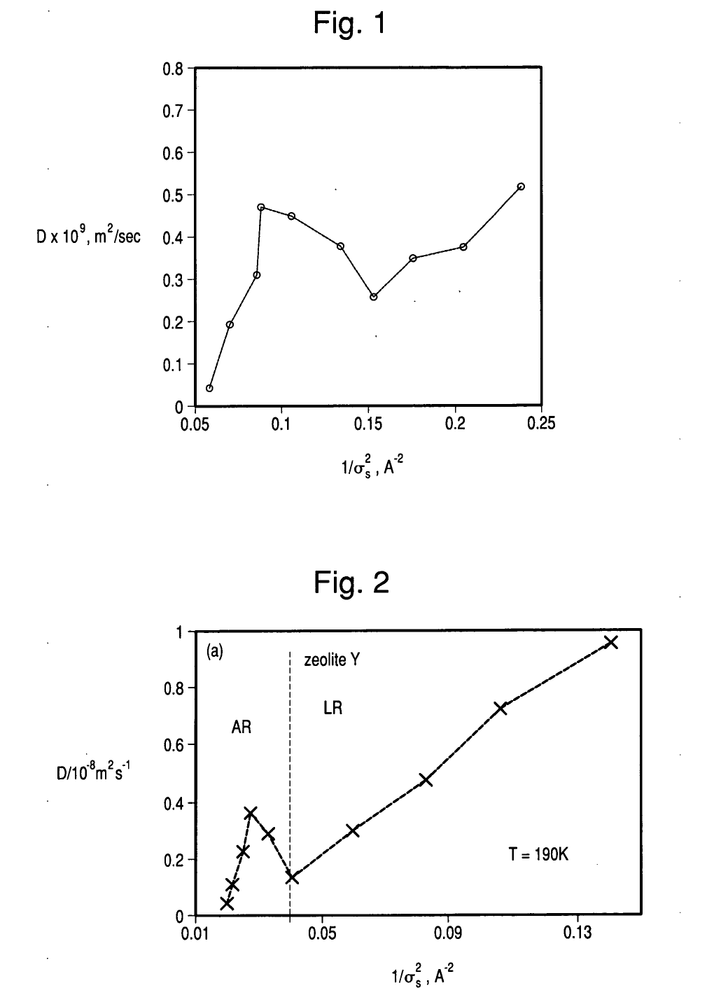

Levitation effect refers to the anomaly in the self-diffusivity that has been observed in porous solids [Reference 21]. Self-diffusivity (D) exhibits a peak at dimensions comparable to the dimension of the pore in the porous solids. For small sizes of the diffusant or the guest, the normally expected linear dependence on the inverse square of the dimensions is observed. Such nonlinear dependence of D on the dimension of the guest species, σ_{gg}, which, in simulations, can be taken to be the Lennard-Jones parameter, is surprising. For small σ_{gg}, D is linearly proportional to 1/σ_{gg}², as expected. This is called the linear regime. (See FIGS. 1, 2, and 3.) However, for larger σ_{gg}, D shows a pronounced peak, which is referred to as the anomalous or the levitation regime (see FIGS. 1, 2, and 3) [Reference 21]. This behavior is characteristic of diffusion in all types of porous solids, irrespective of the geometrical and topological details of the pore network [Reference 23].

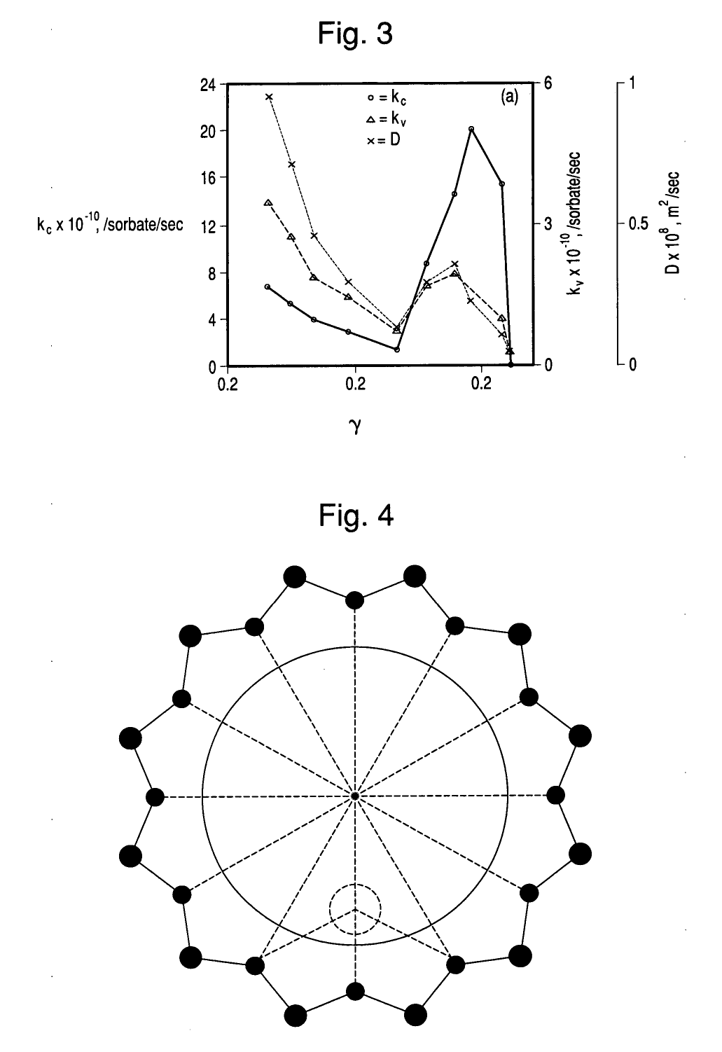

A measure of the levitation effect is the dimensionless parameter [Reference 21] γ=2^{7/6}σ_{gh}/σ_{mw}, where usually σ_{gh}=(σ_{gg}+σₕₕ)/2, with σ_{gh} referring to the guest-host Lennard-Jones interaction parameter and σₕₕ referring to the host-host Lennard-Jones interaction parameter. Physically, 2σ_{gh}=σ_{mw}, where σ_{mw} is the dimension of the molecules of which the diffusant is comprised. In terms of the levitation parameter, γ, the diffusion coefficient decreases for small values of γ, called the linear regime, but shows a peak around γ=1, called the anomalous regime, as shown in FIG. 3. Typically, in most cases studied, the range of γ for the linear regime extends from 0 to about 0.8, but the precise extent of the linear regime should be determined separately for each molecular species (using molecular dynamics simulations). The occurrence of a maximum in self-diffusivity has its origin in the fortuitous cancellation of the dispersion forces on the guest or diffusant due to the host, when the size of the guest is comparable to the pore size (see FIG. 4). Frictional forces on the guest are then their lowest; this results in an increase in D. Under these conditions, the spatial profile of the potential energy of the guest molecules within the pores of the host is rather flat, and displays only small undulations [Reference 24]. The magnitude of the peak in D is dependent on the temperature and degree of disorder in the void network [References 25, 26].

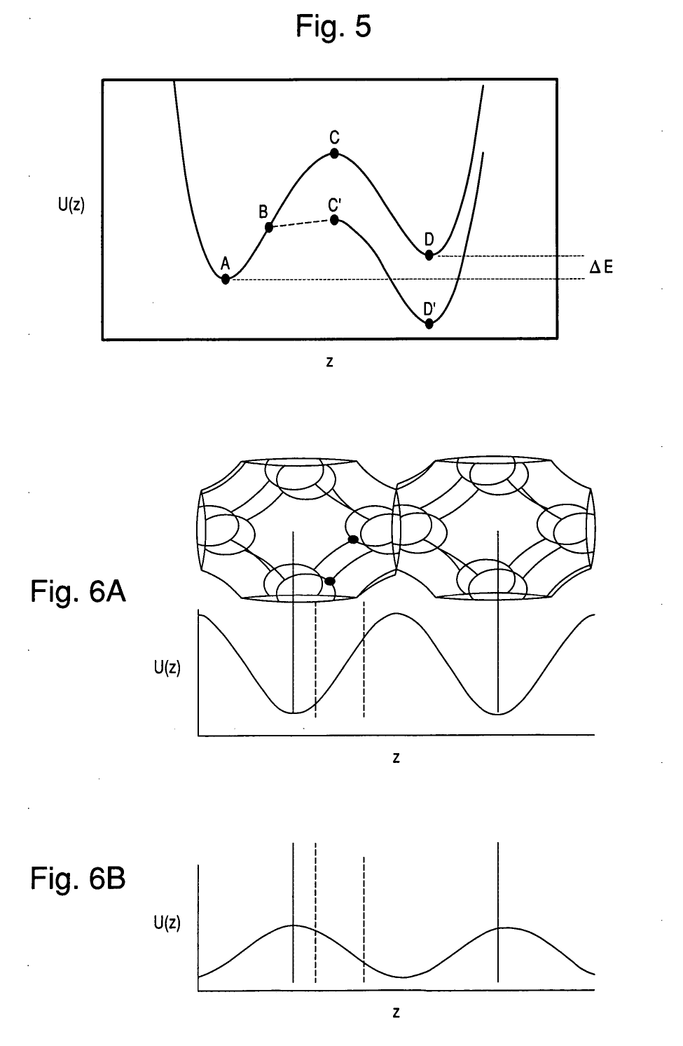

The blow-torch effect was first proposed by Landauer [Reference 22]. Briefly, he showed that introduction of a hot spot in between a lower lying minimum and barrier maximum of a bistable potential can raise the population of the higher lying minimum relative to population of the lower lying minimum over and above that given by the Boltzmann factor. Since the blow-torch effect is rather counter-intuitive, following Landauer [Reference 22], a simple schematic illustration of the effect of a non-uniform temperature bath on the relative populations of competing local energy minima for a bistable potential U(x) is shown in FIG. 5. The effect of the blow-torch is to make the effective potential in the region of the hot spot to be flatter, thereby depressing the minimum at D below the minimum at A (to D′), as shown in FIG. 5. This increases the population of the minimum at D in relation to the population at A.

The driving force experienced by the guest from the linear regime (LR) under the influence of the blow-torch effect is in the opposite direction to that experienced by the guest from the anomalous regime (AR). Suppose the guest from the linear regime has a minimum in the potential energy at some position, say, xₘᵢₙ^{LR} (cage center) within the zeolite and a maximum at xₘₐₓ^{LR} (window). Then, the guest from the anomalous regime has a minimum in the potential energy at the same location where a maximum of the potential is experienced by the guest from the linear regime, xₘₐₓ^{LR}. In other words, xₘᵢₙ^{AR} is located at xₘₐₓ^{LR} and xₘₐₓ^{AR}=xₘᵢₙ^{LR}. This is depicted in FIG. 6. Therefore, hot spots placed periodically at locations in the zeolite network indicated in FIG. 6 drive the two components (of a binary mixture) in the opposite directions.

The first step in the realization of the separation method of the present invention is the specification of the dimensions of molecules. Consider a binary mixture with two components A and B. As noted above, the molecular dimensions of any species are defined by its length, width, and height. The longest of the three dimensions is generally referred to as the length. The width and height are the other two dimensions transverse to the length. For practicing the present invention, the width and height are the two important dimensions. We represent these by σ_{mw}^{(A)}, σₘₕ^{(A)}, σ_{mw}^{(B)}, and σₘₕ^{(B)}, where mw and mh denote the width and height, respectively.

Given a mixture to be separated, the first step is the calculation of the dimensions of the molecules in it:

(i) The molecular dimensions of the components of the mixture can be obtained using DFT-B3LYP/6-31G** with a Gaussian package or from molecular mechanics calculations. Spartan '02 can be used for molecular mechanics calculations. The procedure involves a few steps:

(i) (a) The first step is to perform a molecular mechanics calculation and thereby to obtain the preferred conformation of the molecule.

(i) (b) Using this molecular conformation as the starting point, the molecular geometry is fully optimized using Gaussian with DFT-B3LYP/6-31G** basis set.

(i) (c) Next, using trigonometry, the width, height, and length of the molecule can be determined. This method is described by Jimenez-Cruz and Laredo (Reference 37). To illustrate this, the sizes of the standard paraffins have been listed in Table 3 appended (taken from Jimenez-Cruz and Laredo, Reference 37).

(ii) The second step is to determine the critical molecular dimensions that lead to the selection of a suitable porous solid (host), such as a zeolite, for separating the mixture given. The dimensions of the molecules that are relevant to the choice of the zeolite are the width and the height. The length is not relevant as the molecule generally traverses parallel to its long molecular axis and, therefore, the width and height of the molecule determine whether it can pass through the window of the zeolite or not. Thus, the first step is to identify the largest of the two dimensions for each type of molecule in the binary mixture. For a binary mixture, we define σ_{mw}⁽¹⁾, σₘₕ⁽¹⁾, σ_{mw}⁽²⁾, and σₘₕ⁽²⁾, where mw and mh denote the width and height, respectively. If the mixture is ternary, we define σ_{mw}⁽³⁾, and σₘₕ⁽³⁾, in addition. In the present case (a binary mixture), therefore, four quantities are involved. Let σ_{mw}⁽²⁾ be the largest of this set. Then, the choice of the zeolite required for the separation of the mixture is dictated by σ_{mw}⁽²⁾ of the component 2. From a database, a zeolite is identified that has one of the window dimensions close to a σ_{mw}⁽²⁾ and the other dimension of the window larger than σ_{mw}⁽²⁾. Thus, in this zeolite, the second molecule will be the subject to the levitation effect.

(iii) Window dimensions of zeolites are specified by their width and height. There are several sources readily available that provide structure and geometrical details of zeolites, some of which are given below:

(http://www.univ-lemans.fr/enseignements/chimie/01/divers/zeolites/atlas.html, or from ATS given in Table 4, or Atlas of Zeolite Framework Types by Ch. Baerlocher, W. M. Meier and D. H. Olson [Reference 38]. The latter will be referred to as AZF henceforth in this application). Table 4 of this application is reproduced from this book.

Once the largest dimension in the set σ_{mw}⁽¹⁾, σₘₕ⁽¹⁾, σ_{mw}⁽²⁾, and σₘₕ⁽²⁾, of the binary mixture is identified as, say, σ_{mw}⁽²⁾, the appropriate zeolite for the separation is one which has the dimensions of the window comparable to (σ_{mw}⁽²⁾/2)×2⁷⁶. It must be appreciated that a reasonable range of window dimensions is acceptable. Hence, any zeolite falling within this range would ensure that one component lies in the anomalous regime. The acceptable range is determined by the width of the anomalous regime, and extends over a range of about 2 Å. For example, in the case of zeolite Y, the anomalous regime extends from 5 to 7 Å and, in the case of zeolite A, the range is from 2.5 Å to 4.1 Å.

It is to be noted that errors associated with the determination of the pore and window dimensions (as well as the molecular dimensions) are usually in the range of ±0.3 Å.

The other dimension of the window of the zeolite is required to be larger than σₘₕ⁽²⁾. If these conditions are satisfied, then, an appropriate zeolite for the separation of the given mixture has been identified. Otherwise, the search is repeated until a zeolite that meets the above criteria is found.

In the present invention, the combined influence of the levitation and blow-torch effects, leading to an efficient process for the separation of mixtures, by passing them through porous solids such as zeolites, is disclosed. The physical system illustrating the combined influence consists of a mixture of gases confined to a porous solid, such as the NaCaA zeolite, which has the composition Na₃₂Ca₃₂Si₉₆Al₉₆O₃₈₄ (Si/Al=1.0), crystallizing into a cubic structure (space group Fm3c) with a lattice parameter a=24.55 Å [Reference 29]. In this zeolite, each large cage (supercage, ≈11.4 Å diameter) is connected in an octahedral fashion to 6 other supercages via 8-ring windows of significantly narrower diameter (≈4.5 Å). The distance between two planes of 8-ring windows is given by half of the lattice parameter d_{w}=a/2=12.275 Å. Following earlier work of the present inventors [Reference 28], it is assumed that a species arriving at a heterogeneous zeolite site, typically located between the window and the cage (see FIG. 6) releases an amount of heat q, creating a local hot zone. For the purpose of elucidation, the heat-releasing reaction is mimicked by introducing hot zones at appropriate locations. The presence of a hot zone aids the molecules to surmount a barrier (to diffusion in a specific direction) more easily. Previous investigation by some of the present inventors has shown [Reference 21] that the effective potential energy (PE) landscape for particles in the linear regime (γ typically less than 0.8) is substantially different from the effective potential energy (PE) landscape for particles in the anomalous (γ≈1) regime. For the linear regime, the potential energy maximum and minimum are located, respectively, at the “bottleneck” (8-ring window) and at the cage. For the anomalous regime, they are located at the cage and the “bottleneck”, respectively (see FIG. 6) [Reference 21].

In molecular dynamics simulations carried out leading to the present invention, the system composed of the zeolite and the mixture of gases to be separated is represented by the Lennard-Jones potential φ(r)=4ε[(σ/r)¹²−(σ/r)⁶]. The total interaction energy of the system consists of the guest-guest term φ_{gg}(r) and guest-zeolite term φ_{gh}(r):

$$φ = {\sum }_{i = 1}^{N} {\sum }_{j = 1}^{N} {ϕ}_{gg} + {\sum }_{i = 1}^{N} {\sum }_{j = 1}^{{N}_{z}} {ϕ}_{gh} \qquad ( 3 )$$

where N and N_{z} are the number of guest and zeolite atoms, respectively, and σ is the diameter for sorbate self-interaction. A modified Metropolis Monte Carlo algorithm in the canonical ensemble [Reference 30] was employed. Calculations were carried out at a temperature of T₀=140 K, with the temperature of the hot spot, T_{b}=420 K. Two sets of simulations were carried out, the first (set A) relating to idealized particles to illustrate the effect leading to a high separation factor, and the second (set B) on a realistic mixture of neon-argon. Both set A and set B were modeled in terms of their Lennard-Jones potential parameters. A 1:1 mixture with a total of 256 particles corresponding to a concentration of C=1 per cage (of either type chosen randomly), diffusing with zeolite NaCaA has been simulated. The system consists of 2×2×8 unit cells of zeolite Y, each unit cell containing 8 cages (l_{z}=8×a=196.4 Å). Periodic boundary conditions are imposed along the x- and y-directions. Along the z-direction, repulsive (l/r¹²) walls are placed. For the set A alone, simulations for two mixtures LR and AR, defined by their respective parameters, have been carried out. The mixture LR consists of particles with σ_{gg}=2.05 Å, and 2.38 Å, and mixture AR with σ_{gg}=2.38 Å and 3.34 Å. For the mixture LR, both the components lie in the linear regime (FIGS. 1, 2, and 3). For the mixture AR, one of the two components, viz., σ_{gg}=3.34 Å lies in the anomalous or the levitation regime (FIGS. 1, 2 and 3). The Lennard-Jones interaction parameter ε=0.9977 kJ/mol for all the guests. For the set B simulations of neon-argon mixture, the parameters are [Reference 31]: σ_{Ne—Ne}=2.72 Å, σ_{Ne—Ne}=0.3908 kJ/mol, σ_{Ar—Ar}=3.41 Å, and σ_{Ar—Ar}=0.9977 kJ/mol. Initially, a single particle of either type is placed in each cage, corresponding to the equilibrium distribution in the absence of a blow-torch. There are two cages along each of the x-, y- and z-directions, per unit cell. Hot spots are placed periodically at distances of 1.278 Å to the left of the 8-ring window planes, along the z-direction (see FIG. 6). Simulations comprising of 6×10⁵ MC steps were carried out, which include the initial 5×10⁵ MC steps required for reaching a steady state. Average properties are calculated over 1×10⁵ MC steps.

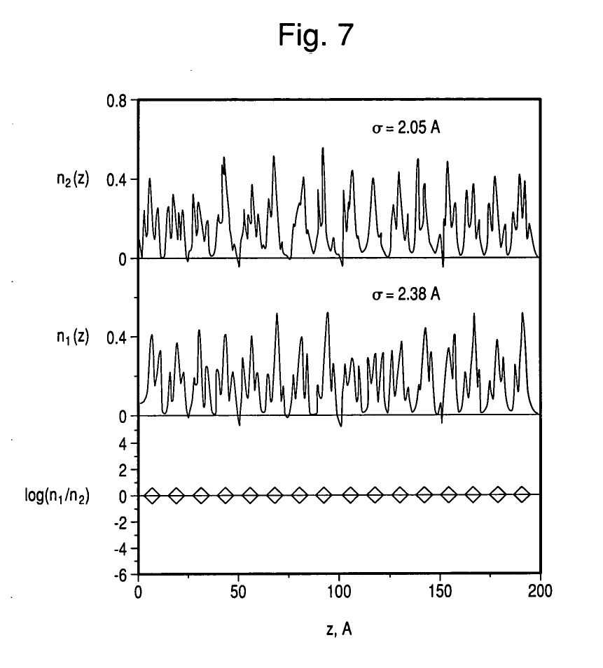

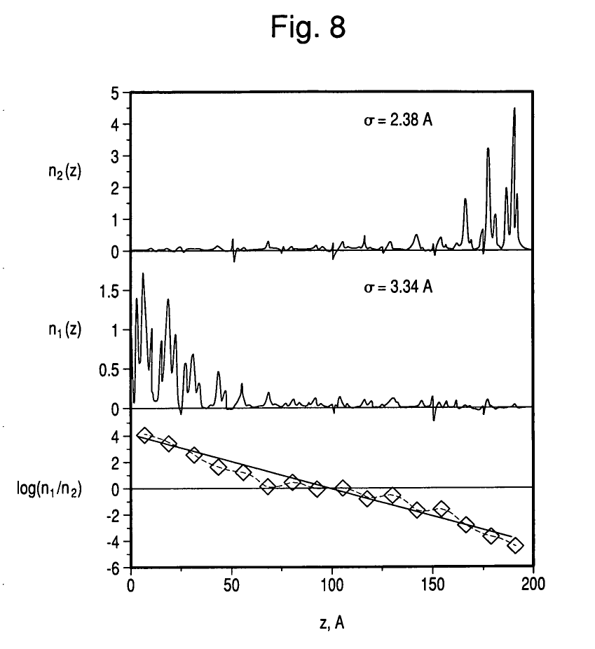

Consider the results of simulations for the LR mixture of set A (with σ_{gg}=2.05 and 2.38 Å). FIG. 7 shows the density profile along the z-direction, nᵢ (z) for i=1.2, together with the logarithm of the ratio n₁(z)/n₂(z) along the z-direction. Clearly, there is hardly any separation of the two components. The separation factor [Reference 20] is of the order of unity. In contrast, the plots of nᵢ(z) for i=1.2 and ln [n₁(z)/n₂(z)] for the mixture AR (with σ_{gg}=2.38 Å and 3.34 Å) show a high degree of separation (FIG. 8). The component corresponding to σ_{gg}=2.38 Å is driven to the right and accumulates at one end, while the other component with σ_{gg}=3.34 Å is driven to the left. At one extreme, the ratio [n₁(z)/n₂(z)] is 72.61 while, at the other extreme, a value of 0.01329 is obtained. This corresponds to a high separation factor [Reference 20] α=5463.

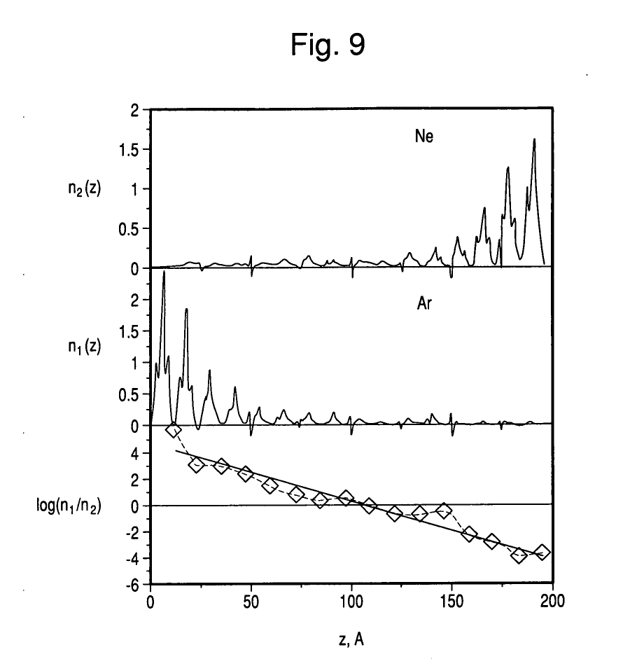

In the following, the application of the method to the separation of a mixture of real gases, namely, a mixture of the rare gases Neon (Ne) and Argon (Ar), using the zeolite NaCaA as the porous host, is described. A plot of n_{Ar}(z), n_{Ne}(z) and their ratio ln [n_{Ar}(Z)/n_{Ne}(z)] as a function z is shown in FIG. 9. Clearly, there is an excellent separation of the two components. At the left end, the ratio [n_{Ar}(z)/n_{Ne}(z)] is 301.81 while at the right extreme it is 0.02255. The resulting separation factor is 1.338×10⁶. Further, use of just a few more unit cells of zeolite can enhance the separation factor by several orders of magnitude.

It is clear from FIGS. 8 and 9, that a straight line fit to the plot of ln [n₁(l)] versus l (alternatively, ln [n_{Ar}(l)/n_{Ne}(l)] versus l) provides a good approximation. Therefore, the ratio [n₁(1)/n₂(1)] [or the ratio n_{Ar}(l)/n_{Ne}(l)] decreases in an exponential way, which can be fitted to:
n₁/n₂=exp(−l/l_{c}+C) (4)
where l is the length of the separation column and l_{c} and C are constants. l_{c}=22.823 Å (mixture AR) and 20.6698 Å (Ne—Ar) and C=4.2851 (mixture AR) and 5.710 (Ne—Ar mixture). Here, we have fixed the magnitude of n₁/n₂(z=0) to be e^{C}. From this, it is easy to estimate that, on doubling the length of the zeolite column from its present value l_{z}=196.4 Å, the ratio at the right extreme is 1.685×10⁻⁶. It follows from equation 4 that the separation factor [Reference 20] for a separation column of length l_{z} may be written

$$α = \frac{{n}_{1} / {n}_{2} ( z = lz )}{{n}_{1} / {n}_{2} ( z = 0 )} = exp ( - {l}_{z} / {l}_{c} )$$

The resulting value for α on doubling the column length is 1.79×10⁸, which is more than two orders of magnitude improvement over the value 1.338×10⁶. In conventional methods of separation, the separation factor increases at best linearly as the length of the column is increased [Reference 20]. By contrast, the present method is capable of providing better than parts per billion purity in the separated components using columns of merely microscopic dimensions. The efficiency of separation is several orders of magnitude higher than that obtained from conventional methods.

These surprising results can be understood by considering the nature of the potential energy landscape for particles in the linear and anomalous regimes (FIG. 6), and the position of the hot spots. Table 1 lists the values of γ for the components of the LR, AR, and Ne—Ar mixtures. In the case of LR mixture, both components fall in the linear regime with their γ values being 0.73 and 0.79 respectively, which are both away significantly less than unity. For these particles, the maxima in the potential energy landscape are at the windows (zₙ=nd_{w}, where n is an integer), just to the right of the hot spots (see FIG. 6a). Thus, the effect of the hot spots is to increase the escape rate over the barrier located to the right of the hot spot. Stationary populations of both species in the presence of hot spots are soon established, which is nearly uniform. In contrast, for the AR mixture or the Ne—Ar mixture (Table 1), while one component lies in the linear regime (γ=0.84), the other component is in the anomalous regime, with γ˜1. For the latter, the potential maxima are located at the cages [zₙ=(2n+1) d_{w}/2, n an integer], which are immediately to the left of the hot spot. Thus, the hot spots have the effect of driving these particles in the anomalous regime in the negative z-direction to the left, while the other component is driven to the right (in the positive z-direction). Since the hot spots are located at periodic positions, the eventual effect is to accumulate particles of the two different types at the left and right extremes, respectively.

It is to be appreciated that the method of the present invention, as elucidated above, depends crucially on the interplay of two factors, namely, the levitation and blow-torch effects. It is applicable to mixtures wherein the components differ in size. The realization of the levitation effect requires a careful choice of the porous host [Reference 32], which depends on a few pertinent points. Investigation carried out earlier by one of the present inventors shows that the enhancement of D within the anomalous regime extends over a reasonably large range of σ_{gg} [Reference 25]. This provides considerable flexibility in the choice of the host porous solid in which the anomalous regime is to be realized, in order to achieve separation of a given mixture. There exist in nature a number of known porous solids [Reference 33] with a wide variation in pore dimensions. Further, it is also possible to tailor the pore dimensions of these solids through, for instance, substitution of framework ions. Substitution of Si by AI or Si by P or AI by Ti can alter the pore dimensions [Reference 34]. Table 2 illustrates the choice of an appropriate zeolite as the host for a few “practical” mixtures [Reference 33]. For the hydrocarbon mixture consisting of n-hexane, n-butane, and isopentane, it is seen that isopentane alone has a γ value close to unity and, therefore, in an application of the present method to this mixture, isopentane alone would be driven to the left, while the other two would be driven to the right. Thus, it is possible to separate out isopentane from other components. In the binary mixture of CCl₄ and CF₄, the component with γ value closer to unity is would be driven to left and the other component with γ=0.692 will be driven to the right.

The efficacy of the present invention in the separation of mixtures employing zeolites as the porous host solids, has been successfully demonstrated [Reference 35]. It is to be appreciated that the method of the present invention is fundamentally different from methods known in the art: the combined result of the levitation and blow-torch effects is to force the components of the mixture in opposite directions, leading to very high degrees of separation. By contrast, existing methods of separation drive both the components in the same direction, but at different rates. For example, in distillation, the vapour pressure of both components increases on heating. Or, an increase in concentration gradient may lead to higher self-diffusivities of both the species. Consequently, the separation factor is limited by the differential between the various components. Significant to the reduction of the present invention to practice is that, the instant method achieves separation at microscopic length scales of the separation column, in contrast with the macroscopic length scales in the separation methods known in the art. This benefit accrues from the synergistic combination of the levitation and blow-torch effects.

An important and crucial aspect of the present invention is the method of inducing hot spots required for the realization of the blow-torch effect simultaneously with the levitation effect. The latter is ensured by the choosing a porous solid appropriate for the separation of a given mixture. The positions in the zeolite network where hot spots are induced should be periodic in the direction in which the separation is to be achieved. The positions in the unit cell of a typical porous solid (host) are shown in FIG. 6.

To create hot spots, enough energy is “pumped” to a localized region of a porous solid, such as a zeolite, using appropriate chemical groups. The vibrational modes of zeolites have frequencies in the range 10-1100 cm⁻¹. Therefore, a chemical group with its vibrational frequency not overlapping with the vibrational modes/frequencies of the zeolite (chosen for the separation of a given mixture) is identified. A chemical group whose vibrational frequency is outside this range is C═CH₂, with a frequency of about 1600 cm⁻¹. Such a group is attached on one side of each window of the zeolite framework, either preceding or following the window, in a repetitive manner along one direction, say the z-direction, as shown in FIG. 6. The chemical group is bonded to the zeolite framework between the cage center and the window, typically about 1 Å or 2 Å away from the plane of the window.

In a preferred embodiment of the present invention, therefore, a beam of infrared light with frequencies in the vicinity of 1600 cm⁻¹ is used to irradiate the zeolite. This excites selectively the vibrational modes of the chemical group in the C═CH₂ group in the example considered. In particular, the C═C bond vibration is excited. The deexcitation that follows releases energy, resulting in a hot spot locally. It must be appreciated that zeolites and other porous solids are poor thermal conductors. This aids in the “retention” of the hot spots created as above during the separation process. Once the zeolite is irradiated with infrared light of an appropriate range of frequencies, the mixture to be separated is allowed to enter the zeolite. Since the hot spots have already been activated, the combined influence of levitation and blow-torch effects drives the two components in opposite directions. The temperature of the hot spot can be controlled by the intensity of infrared beam or by changing the continuous irradiation to irradiation with a pulsed beam of an appropriate pulse rate. A zeolite column less than a micrometer in length, and often, a column length of just a few nanometers would be sufficient to achieve a separation factor of ≈10⁶ or greater.

An alternate embodiment of the present invention for the realization of hot spots required for the blow-torch effect emerges from the results obtained by Blanco and Auerbach (Reference 36). These authors show that, when a mixture of methanol and benzene adsorbed in a zeolite is subjected to microwave radiation, the temperature of methanol is higher by nearly 100° C. higher than the temperature of benzene. This is attributed to the fact that methanol has a dipole moment, and therefore absorbs microwave radiation, while benzene is a poor absorber as it does not have a dipole moment.

This result is the basis of an alternate embodiment of the present invention for the realization of hot spots at periodic locations in the host porous solid, as required for the combination of the levitation and blow-torch effects for the efficient separation of components in a mixture. Thus, chemical groups with a dipole moment, such as —OH, —CN, —CF, etc., may be attached at selected periodic locations in the pores of the host, where hot spots are desired. Irradiation with microwaves of an appropriate range of frequencies, and the absorption of the radiation by the chemical groups so attached, combined with the low thermal conductivity of porous solids, leads to hot spots at these locations.

Consider the combined influence of the levitation and blow-torch effects on a (binary) mixture of guest molecules, with one component belonging to the linear regime and the other to the anomalous regime. For this case, when the dimensions of the molecule are small compared to the window dimensions of the zeolite, the potential energy has minima at cage centers and maxima at the windows. By contrast, for molecules whose diameter is close to the window diameter, the potential has its maxima located at the cage centers and minima at the windows (see FIG. 6). The effect of hot spots located between the minimum and maximum of a potential is always to enhance the transport in the direction connecting the minimum and the maximum. Thus, because the nature of the potential seen by the guest from the linear regime and anomalous regime are different, the presence of hot spots located periodically in the z-direction as shown in FIG. 6, is to drive the molecules belonging to the linear regime in the positive z-direction, while those belonging to the anomalous regime are driven in the negative z-direction.

Thus, both the levitation and blow-torch effects lead to enhanced diffusivity. Specifically, controlling the direction along which two or more components diffuse (or the channelising of their diffusion) can achieve significant or even drastic improvement of the separation factors. A judicious combination of these two effects therefore can drive different components in opposite directions. Such a combination is of considerable significance to the separation of mixtures, and forms the conceptual basis for a new method for the separation of mixtures, which helps to realize separation factors (see below) that are quantitatively superior by several orders of magnitude to the existing methods. Since both the blow-torch and levitation effects can be realized in zeolites, their combined effect on the separation of a mixture of gases confined to zeolites is illustrated below through several examples. In the case of porous hosts such as a zeolite, the synergistic combination of the levitation and blow-torch effects leads to a significant reduction in the length of the separation column through which the mixture must traverse from macroscopic to microscopic dimensions (typically to the range of tens to hundreds of nanometers). This is demonstrated using Monte Carlo simulations for (i) Lennard-Jones mixtures and (ii) Ne—Ar mixture.

The energy cost associated with the present method is significantly lower than in the existing methods. While the hot spots required in the present method will add to the energy cost of the method, the microscopic length of the separation column required for achieving separation means that the number of hot spots to be maintained is small. Thus, the total energy cost is much smaller than in conventional methods. Most of the energy cost in existing methods of separation is due to the high temperatures that need to be maintained over long columns. By contrast, the energy saved in the present method is in approximate proportion to the reduction in the length of the column length.

The reduction in the energy cost that the present invention provides may be appreciated further by contrasting with the energy cost of achieving similarly high separation factors in existing methods. Existing methods would require prohibitively long separation columns or iterative separation steps (either of which incurs a high energy and economic cost) to achieve separation factors obtained by the instant invention.

As an illustration of the effectiveness of the above method, the conventional method of separation of hydrocarbon using zeolites must be appreciated. [Reference 20]. In these methods, the separation factor is controlled by geometrical features such as size and shape of the molecules. However, if the method of the present invention is employed, an appropriate choice of the zeolite for the realization of the levitation effect, together with suitably engineered hot spots, yields a large improvement in separation factor for hydrocarbons.

While the present exercise illustrates the combined use of blow torch and levitation effect in the context of separation of gas mixtures, the method of separation is not limited to gases, because the levitation and blow-torch effects apply to any species that are driven to traverse through a porous solid, including ions and biological entities. The present invention therefore provides a mechanism by which ions diffusing across bio-membranes can do so with minimum activation energy. Further, the levitation effect provides that, when the channel dimension through which the ions diffuse approximates the size of the ion, then, the activation energy for diffusion is lowest [Reference 25]. Further, the present invention provides for the design of drug delivery systems, wherein an encapsulated drug may be released at the desired location in the body through the release of heat, i.e., a hot spot, created through externally provided radiation. The thermal energy injected enhances diffusivity, leading to dispersal of the drug.

We now illustrate the implementation of the method of the present invention for the separation of mixtures of non-spherical molecules through several examples. The discussion is restricted to binary mixtures. However, it will be evident to those skilled in the art that the method is applicable in general. Repeated application of the method, using an appropriate porous solid at each step enables the separation of individual components of a multi-component mixture.

The first step in the implementation is the selection of an appropriate porous solid for the separation of a mixture comprising a given binary set of non-spherical molecules, say hydrocarbons. Spherical molecules are a special case. The separation of hydrocarbons is important in the petrochemical industry, where the present invention is anticipated to be widely applicable. It is to be appreciated that the method as detailed below is applicable to molecules other than those of hydrocarbons and to porous solids other than zeolites. As zeolites have been employed extensively in the separation of hydrocarbons using zeolites as molecular sieves, it is appropriate to illustrate the method of the present invention by applying it to a mixture of hydrocarbons.

To do so, it is necessary first to obtain the dimensions (defined by their length, width and height) of the molecules comprising the binary mixture under consideration. For illustration, the dimensions of the binary molecular mixtures in the examples here are taken from Table 3 of Reference [37]. The table of dimensions refers to the dimensions of paraffin (linear and branched), which have been obtained by density functional theory (DFT) quantum chemical calculations and are considered reliable. The error in computation is ±0.3 Å. It is to be noted that, in the literature, the dimensions of windows of zeolites are often denoted by com-com diameter that includes the free diameter in addition to the diameter of the host molecules.

Given the binary mixture, the next step is the selection of a zeolite appropriate for their effective separation. To enable this, the structure of naturally occurring zeolites and their window dimensions are readily available in the literature. The dimension of pores in zeolites can range from 3 Å to 13 Å, as can be seen from the Table 4 appended to hereto. Synthetic zeolites of desired dimensions may also be considered for selection. These dimensions refer to the free dimensions of the window that specifies the dimensions of the molecules that can be fitted into the pores.

The technology of the instant Application is further elaborated with the help of following examples. However, the examples should not be construed to limit the scope of the invention.

### EXAMPLE 1

### A Mixture of n-pentane (NC5) and neopentane

A common problem in petroleum industries is the separation of linear and branched hydrocarbons, such as that of a binary of mixture of the isomers n-pentane and neopentane. The molecular dimensions n-pentane are (4.846×4.154 Å) and those of neopentane are (5.52×6.74 Å). Therefore, the value of 2^{7/6}×σ_{gh}=2^{7/6}×σ_{mw}/2, (where σ_{mw} refers to the width of the molecule), is, respectively, 5.44 Å and 7.565 Å. Hence, these two isomers can be separated using zeolite Y (which has a free diameter 7.4 Å).

The corresponding γ values for n-pentane and neopentane are, respectively, 0.735 and 1.022 (with an error bar of ±0.04). Hence, neopentane lies in the anomalous regime near the maximum, while n-pentane lies in the linear regime. In selecting the zeolite, care should be exercised to ensure that the second dimension of the window pore is larger than the smaller dimension of the larger molecule, so that it will pass through the pore without difficulty. Employing a zeolite so selected, the two components of the binary mixture will be driven in opposite directions in the presence of hot spots.

Zeolite Y consists of large cages known as supercages of approximate diameter 11.8 Å, interconnected through 12-ring windows. Each cage in turn is connected to four other similar cages placed tetrahedrally. The 12-ring windows have a free diameter of 7.4 Å.

### EXAMPLE 2

### A Mixture of n-decane and 3-methylpentane (3MC5)

The hydrocarbon n-decane has molecular dimensions of 4.85×4.15 Å while the dimensions of 3MC5 are 6.22×5.48 Å. The largest of these dimensions, 6.22 Å, belongs to 3MC5. The numerical factor given by 2^{7/6}×σ_{gh}=2^{7/6}×σ_{mw}/2 is 6.98 Å for 3MC5, while it is 5.44 Å for n-decane. It is known that zeolite NaY has a window diameter of 7.4 Å. Using this, the γ value for 3MC5 is deduced to be 0.94, while that for n-decane is 0.73. From the plot of D versus γ for zeolite Y shown in FIG. 3, we see that 3MC5 lies in the anomalous regime, while n-decane lies near the end of the linear regime. Thus, the application of hot spots at appropriate locations in a column of zeolite NaY leads to very good separation of a mixture of n-decane and 3-methylpentane (3MC5).

### EXAMPLE 3

### A mixture of 2,2-dimethylbutane (22DMC4) and n-hexane

The molecular dimensions of 22DMC4 are 5.672×6.74 Å, while those of n-hexane are 4.846×4.154 Å (Reference 39). Therefore, the numerical factor 2^{7/6}×σ_{gh}=2^{7/6}×σ_{mw}/2 is 7.565 Å for 22DMC4, while it is 5.44 Å for n-hexane. As zeolite NaY has a free diameter of 7.4 Å, either NaY or another zeolite, such as NaX with 12-membered rings, would be appropriate for the separation of the present binary mixture. For NaY, the γ values for 22DMC4 and n-hexane are 1.02 and 0.73, respectively (with an error bar of ±0.04) (Reference 33). Thus, the levitation parameter γ for 22DMC4 in the zeolite NaY is close to unity, placing it in the anomalous regime, while n-hexane lies in the linear regime. Therefore, the components of a binary mixture of 22DMC4 and n-hexane can be separated efficiently with the introduction of hot spots in zeolite NaY (or NaX).

### EXAMPLE 4

### A mixture of 2,2-Dimethylpropane (22DMC3) and n-Pentane (NC5)

The molecular dimensions of 22DMC3 are 5.52×6.74 Å, they are 4.84×4.15 Å for NC-5. Of these two molecules, 22DMC3 has both dimensions larger than those of NC5. Therefore, the larger dimension of 22DMC3, namely 6.74 Å, dictates the choice of the zeolite to be employed for separation using the method of the instant invention. The numerical parameter 2^{7/6}×σ_{gh}=2^{7/6}×σ_{mw}/2 is 7.516 Å for 22DMC3. Consultation of Table: 5 reveals that 7.516 Å is close to the dimensions of the 12-ring zeolite faujasite (window dimensions 7.4×7.4 Å). Thus, the γ value for the molecule 22DMC3 is very close to unity (1.022±0.04). Thus, 22DMC3 falls in the anomalous regime of diffusion in faujasite. By contrast, the value of γ for NC5 is 0.65±0.04, placing it in the linear regime of diffusion through faujasite. Hence, through the introduction of hot spots in a separation column made of faujasite, a high degree of separation of the mixture under consideration will be achieved.

### EXAMPLE 5

### A Mixture of 3-ethylhexane (3EC6) and 2, 4-Dimethylhexane (24DMC6)

The molecular dimensions of 3-ethylhexane (3EC6) 7.65×6.3 Å, while the dimensions of 2,4-Dimethylhexane (24DMC6) are 6.259×5.414 Å. Thus, 3EC6 has the larger dimension (7.65 Å), and the numerical factor of Eq. 2 given by 2^{7/6}×σ_{gh}=2^{7/6}×σ_{mw}/2 is 8.586 Å. Reference to the window dimensions of different zeolites listed in Table: 5, reveals that the zeolite AlPO-8 is the appropriate choice, because of its pore dimensions of 7.9×8.7 Å. The γ value for 3EC6 is 0.987±0.0345, very close to unity, clearly placing it in the anomalous regime. A similar calculation for the smaller molecule (24DMC6) gives γ=0.807±0.0345, placing it in the linear regime. It is to be appreciated that 7.9 Å is larger than the smallest dimension of both the molecules that make up the mixture. Thus, 3EC6 lies in the anomalous regime while 24DMC6 lies in the linear regime. Therefore, using a column of the zeolite AlPO-8, and with the application of hot spots at required locations, the two components of the present mixture are driven in the opposite directions, leading to excellent separation.

### EXAMPLE 6

### Ternary Mixture of 3-ethylhexane (3EC6), 2,4-Dimethylhexane (24DMC6) and n-pentane

This is an example of a three-component mixture, to illustrate how the present invention is extended to the separation of multicomponent mixtures. The molecular dimensions of 3-ethylhexane (3EC6) are 7.65×6.3 Å, while those of 2,4-Dimethylhexane (24DMC6) are 6.259×5.414 Å, and those of n-pentane (4.846×4.154 Å). Of these, 3EC6 has the largest dimension (7.65 Å) and the value of the numerical factor of Eq. 2 given by 2^{7/6}×σ_{gh}=2^{7/6}×σ_{mw}/2 is 8.586 Å. This factor for 24DMC6 is 7.06 Å, and, for n-pentane, it is 5.44 Å. Reference to the list of window dimensions of different zeolites given in Table: 4 shows that that the zeolite AlPO-8 is the appropriate choice for the separation of the present mixture, because it has pores measuring 7.9×8.7 Å. The value of γ for 3EC6 is 0.987±0.0345, while that for 24MC6 is 0.807±0.0345, and the value of γ for n-pentane is 0.625±0.0345. Thus, 3EC6 lies in the anomalous regime, while both 24MC6 and n-pentane are clearly in the linear regime. It must be noted that 7.9 Å is larger than the smallest dimension of all the molecules that make up the mixture. With the application of hot spots at required locations in a separation column made of AlPO-8, the component 3EC6 is driven in the direction opposite to that of the other two components leading to excellent separation of 3EC6 from the mixture. This leaves a binary mixture of 24DMC6 and n-pentane.

To effect the separation of the remnant binary mixture, it is to be recalled (from above) noted that the numerical factor of Eq. 2 given by 2^{7/6}×σ_{gh}=2^{7/6}×σ_{mw}/2 for 24DMC6 is 7.06 Å, while that for n-pentane is 5.44 Å. By referring to the table of zeolite dimensions, it can be inferred that an appropriate choice of the zeolite that would place the larger molecule 24DMC6 in the anomalous regime is zeolite Y, which has a free dia 7.4 Å. This choice of the zeolite leads to γ values of 0.95 for 24DMC6 and 0.735 for n-pentane. Thus, 24DMC6 lies in the anomalous regime and n-pentane in the linear regime, when a column of zeolite Y is used for the separation of the binary mixture of 24DMC6 and n-pentane. The application of hot spots leads to good separation of the two components.

It may be appreciated from Example 6 that the method of the present invention can be used for the separation of multicomponent mixtures, through an iterative application of the method.

Several aspects of the invention are described above with reference to examples for illustration. It should be understood that numerous specific details, relationships, and methods are set forth to provide a full and complete understanding of the invention. It should be understood by those skilled in the relevant art(s) that various changes may be made and equivalents may be substituted without departing from the true spirit and scope of the invention as defined by the appended claims. In addition, many modifications may be made to adapt a particular situation, material, composition of matter, method, process step or steps, to the objective, spirit, and scope of the present invention. All such modifications are intended to be within the scope of the claims appended hereto.

TABLE 1
The value of γ defined in Eq. 2 for different guests in zeolite A.

| σ_{gg,} Å | γ |
|---|---|
| 2.05 | 0.73 |
| 2.38 | 0.79 |
| 3.34 | 0.94 |
| 2.72 (Ne) | 0.84 |
| 3.405 (Ar) | 0.95 |

TABLE 2
Choice of zeolite for hydrocarbon and other mixtures chosen so that
one of the components has a value of γ close to unity.

| System | 2^{7/6} σ_{gh,} | γ | Zeolite |
|---|---|---|---|
| Isopentane | 10.03 | 0.995 | faujasite^{a} |
| n-hexane | 8.08 | 0.799 | |
| n-butane | 8.08 | 0.799 | |
| CCl₄ | 8.39 | 0.829 | faujasite |
| CF₄ | 6.99 | 0.692 | |

TABLE 3
Taken from F. Jimenez-Cruz and G. C. Laredo, Fuel, Vol. 83, p. 2189
(2004) [Reference 37].
Critical molecular parameters for the paraffins, in Å and Å³

| | | | | | CPK molecular | |
|---|---|---|---|---|---|---|
| Name | Entry | Length | Height | Width | volume | w-h |
| n-Pentane | NC5 | 9.315 | 4.846 | 4.154 | 107.500 | 4.500 |
| n-Hexane | NC6 | 10.617 | 4.846 | 4.154 | 125.480 | 4.500 |
| n-Heptane | NC7 | 11.880 | 4.850 | 4.150 | 143.910 | 4.500 |
| n-Octane | NC8 | 13.170 | 4.850 | 4.150 | 162.350 | 4.500 |
| 2-Metilbutane | 2MC4 | 8.032 | 6.350 | 5.480 | 106.690 | 5.915 |
| 2-Methylpentane | 2MC5 | 9.316 | 6.360 | 5.500 | 125.120 | 5.930 |
| 2-Methylhexane | 2MC6 | 10.594 | 6.360 | 5.460 | 143.560 | 5.910 |
| 2-Methylheptane | 2MC7 | 11.789 | 6.390 | 5.440 | 162.010 | 5.915 |
| 3-Methylpentane | 3MC5 | 9.257 | 6.220 | 5.483 | 124.900 | 5.852 |
| 3-Methylhexane | 3MC6 | 10.558 | 6.353 | 5.483 | 143.250 | 5.918 |
| 3-Methylheptane | 3MC7 | 11.782 | 6.370 | 5.467 | 161.670 | 5.919 |
| 4-Methylheptane | 4MC7 | 11.856 | 6.805 | 5.467 | 161.600 | 6.136 |
| 3-Ethylpentane | 3EC5 | 9.243 | 7.600 | 6.110 | 143.510 | 6.855 |
| 3-Ethylhexane | 3EG6 | 10.553 | 7.650 | 6.300 | 162.060 | 6.975 |
| 2,2-Dimethylpropane | 22DMC3 | 6.744 | 5.524 | 6.744 | 106.050 | 6.134 |
| 2,2-Dimethylbutane | 22DMC4 | 8.031 | 5.612 | 6.744 | 124.350 | 6.178 |
| 2,2-Dimethylpentane | 22DMC5 | 9.334 | 5.616 | 6.720 | 142.790 | 6.168 |
| 2,2-Dimethylhexane | 22DMC6 | 10.600 | 5.618 | 6.743 | 161.230 | 6.181 |
| 2,3-Dimethylbutane | 23DMC4 | 8.045 | 6.898 | 5.472 | 124.440 | 6.185 |
| 2,3-Dimethylpentane | 23DMC5 | 9.304 | 6.975 | 5.448 | 142.700 | 6.212 |
| 2,3-Dimethylhexane | 23DMC6 | 10.558 | 7.025 | 5.482 | 161.200 | 6.254 |
| 2,4-Dimethylpentane | 24DMC5 | 9.203 | 6.259 | 5.414 | 143.260 | 5.837 |
| 2,4-Dimethylhexane | 24DMC6 | 10.413 | 6.231 | 5.483 | 161.620 | 5.857 |
| 2,5-Dimethylhexane | 25DMC6 | 10.608 | 7.550 | 5.471 | 161.620 | 6.511 |
| 3,3-Dimethylpentane | 33DMC5 | 9.230 | 5.565 | 6.742 | 142.560 | 6.154 |
| 3,3-Dimethylhexane | 33DMC6 | 10.560 | 5.608 | 6.744 | 161.020 | 6.176 |
| 3,4-Dimethylhexane | 34DMC6 | 10.602 | 7.045 | 5.436 | 160.980 | 6.241 |
| 2-Methyl-3-ethylpentane | 2M3EC5 | 9.308 | 8.316 | 6.750 | 161.230 | 7.533 |
| 3-Methyl-3-Ethylpentane | 3M3EC5 | 9.203 | 7.650 | 6.717 | 160.550 | 7.184 |
| 2,2,3-Trimethylbutane | 223TMC4 | 8.038 | 6.509 | 6.748 | 142.070 | 6.629 |
| 2,2,3-Trimethylpentane | 223TMC5 | 9.300 | 6.778 | 6.748 | 160.370 | 6.763 |
| 2,2,4-Trimethylpentane | 224TMC5 | 9.299 | 6.350 | 6.743 | 160.670 | 6.547 |
| 2,3,3-Trimethylpentane | 233TMC5 | 9.275 | 6.666 | 6.750 | 160.180 | 6.708 |
| 2,3,4-Trimethylpentane | 234TMC5 | 9.318 | 6.928 | 5.447 | 159.320 | 6.188 |
| 2,2,3,3,-Tetramethylbutane | 2233TMC4 | 8.056 | 7.930 | 6.756 | 159.160 | 7.343 |

TABLE 4
Channel dimensions taken from Ch. Baerlocher, W. M. Meier and D. H. Olson, Atlas
of Zeolite Framework Types, 5^{th} edition, Elsevier, 2001 [Reference 38].
20-, 18- &14-Ring Structures

| | | | |
|---|---|---|---|
| -CLO | Cloverite | <100> 20 4.0 × 13.2*** \| | <100> 8 3.8 × 3.8*** |
| VFI | VPI-5 | [001] 18 12.7 × 12.7* | |
| AET | AlPO-8 | [001] 14 7.9 × 8.7* | |
| CFI | CIT-5 | [010] 14 7.2 × 7.5* | |
| DON | UTD-1F | [010] 14 8.1 × 8.2* | |
| OSO | OSB-1 | [001] 14 5.4 × 7.3* | [001] 8 2.8 × 3.3** |

12-Ring Structures

| | | | | |
|---|---|---|---|---|
| AFI | AlPO-5 | [001] 12 7.3 × 7.3* | | |
| AFR | SAPO-40 | [001] 12 6.7 × 6.9* | [010] 8 3.7 × 3.7* | |
| AFS | MAPSO-46 | [001] 12 7.0 × 7.0* | [001] 8 4.0 × 4.0** | |
| AFY | CoAPO-50 | [001] 12 6.1 × 6.1* | [001] 8 4.0 × 4.3** | |
| ASV | ASU-7 | [001] 12 4.1 × 4.1* | | |
| ATO | AlPO-31 | [001] 12 5.4 × 5.4* | | |
| ATS | MAPO-36 | [001] 12 6.5 × 7.5* | | |
| *BEA | Beta | <100> 12 6.6 × 6.7** | [001] 12 5.6 × 5.6* | |
| BOG | Boggsite | [100] 12 7.0 × 7.0* | [010] 10 5.5 × 5.8* | |
| BPH | Beryllophosphate-H | [001] 12 6.3 × 6.3* | [001] 8 2.7 × 3.5** | |
| CAN | Cancrinite | [001] 12 5.9 × 5.9* | | |
| CON | CIT-1 | [001] 12 6.4 × 7.0* | [100] 12 7.0 × 5.9* | |
| | | [010] 10 5.1 × 4.5* | | |
| CZP | Chiral Zincophosphate | [001] 12 3.8 × 7.2* | | |
| DFO | DAF-1 | {[001] 12 7.3 × 7.3 | [001] 8 3.4 × 5.6}*** | |
| | | {[001] 12 6.2 × 6.2 | [001] 10 5.4 × 6.4}*** | |
| EMT | EMC-2 | [001] 12 7.3 × 7.3* | [001] 12 6.5 × 7.5** | |
| FAU | Faujasite | <111> 12 7.4 × 7.4*** | | |
| GME | Gmelinite | [001] 12 7.0 × 7.0* | [001] 8 3.6 × 3.9** | |
| GON | GUS-1 | [001] 12 5.4 × 6.8* | | |
| IFR | ITQ-4 | [001] 12 6.2 × 7.2* | | |
| ISV | ITQ-7 | <100> 12 6.1 × 6.5** | [001] 12 5.9 × 6.6* | |
| LTL | Linde Type L | [001] 12 7.1 × 7.1* | | |
| MAZ | Mazzite | [001] 12 7.4 × 7.4* \| | [001] 8 3.1 × 3.1*** | |
| MEI | ZSM-18 | [001] 12 6.9 × 6.9* | [001] 7 3.2 × 3.5** | |
| MOR | Mordenite | [001] 12 6.5 × 7.0* | {[010] 8 3.4 × 4.8 | [001] 8 2.6 × 5.7}* |
| MTW | ZSM-12 | [010] 12 5.6 × 6.0* | | |
| OFF | Offretite | [001] 12 6.7 × 6.8* | [001] 8 3.6 × 4.9** | |
| OSI | UiO-6 | [001] 12 5.2 × 6.0* | | |
| -RON | Roggianite | [001] 12 4.3 × 4.3* | | |
| SAO | STA-1 | <100> 12 6.5 × 7.2** | [001] 12 7.0 × 7.0* | |
| SBE | UCSB-8Co | <100> 12 7.2 × 7.4** | [001] 8 4.0 × 4.0* | |
| SBS | UCSB-6GaCo | [001] 12 6.8 × 6.8* | [001] 12 6.9 × 7.0** | |
| SBT | UCSB-10GaZn | [001] 12 6.4 × 7.4* | [001] 12 7.3 × 7.8** | |
| SFE | SSZ-48 | [010] 12 5.4 × 7.6* | | |
| VET | VPI-8 | [001] 12 5.9 × 5.9* | | |

10-Ring Structures

| AEL | AlPO-11 | [001] 10 4.0 × 6.5* | | |
|---|---|---|---|---|
| AFO | AlPO-41 | [001] 10 4.3 × 7.0* | | |
| AHT | AlPO-H2 | [001] 10 3.3 × 6.8* | | |
| CGF | Co—Ga-Phosphate-5 | {[100] 10 2.5 × 9.2* + 8 2.1 × 6.7*} | | [001] 8 2.4 × 4.8* |
| CGS | Co—Ga-Phosphate-6 | {[001] 10 3.5 × 8.1 | [100] 8 2.5 × 4.6*** | |
| DAC | Dachiardite | [010] 10 3.4 × 5.3* | [001] 8 3.7 × 4.8* | |
| EPI | Epistilbite | [100] 10 3.4 × 5.6* | [001] 8 3.7 × 4.5* | |
| EUO | EU-1 | [100] 10 4.1 × 5.4* | | |
| FER | Ferrierite | [001] 10 4.2 × 5.4* | [010] 8 3.5 × 4.8* | |
| HEU | Heulandite | {[001] 10 3.1 × 7.5* + 8 3.6 × 4.6*} | | [100] 8 2.8 × 4.7* |
| LAU | Laumontite | [100] 10 4.0 × 5.3* | | |
| MEL | ZSM-11 | <100> 10 5.3 × 5.4*** | | |
| MFI | ZSM-5 | {[100] 10 5.1 × 5.5 | [010] 10 5.3 × 5.6}*** | |
| MFS | ZSM-57 | [100] 10 5.1 × 5.4* | [010] 8 3.3 × 4.8* | |
| MTT | ZSM-23 | [001] 10 4.5 × 5.2* | | |
| MWW | MCM-22 | [001] 10 4.0 × 5.5** \| | [001] 10 4.1 × 5.1** | |
| NES | NU-87 | [100] 10 4.8 × 5.7** | | |
| -PAR | Partheite | [001] 10 3.5 × 6.9* | | |
| SFF | SSZ-44 | [001] 10 5.4 × 5.7* | | |
| STF | SSZ-35 | [001] 10 5.4 × 5.7* | | |

12-Ring Structures (cont.)

| | | | | |
|---|---|---|---|---|
| MEI | ZSM-18 | [001] 12 6.9 × 6.9* | [001] 7 3.2 × 3.5** | |
| MOR | Mordenite | [001] 12 6.5 × 7.0* | {[010] 8 3.4 × 4.8 | [001] 8 2.6 × 5.7}* |
| MTW | ZSM-12 | [010] 12 5.6 × 6.0* | | |
| OFF | Offretite | [001] 12 6.7 × 6.8* | [001] 8 3.6 × 4.9** | |
| OSI | UiO-6 | [001] 12 5.2 × 6.0* | | |
| -RON | Roggianite | [001] 12 4.3 × 4.3* | | |
| SAO | STA-1 | <100> 12 6.5 × 7.2** | [001] 12 7.0 × 7.0* | |
| SBE | UCSB-8Co | <100> 12 7.2 × 7.4** | [001] 8 4.0 × 4.0* | |
| SBS | UCSB-6GaCo | [001] 12 6.8 × 6.8* | [001] 12 6.9 × 7.0** | |
| SBT | UCSB-10GaZn | [001] 12 6.4 × 7.4* | [001] 12 7.3 × 7.8** | |
| SFE | SSZ-48 | [010] 12 5.4 × 7.6* | | |
| VET | VPI-8 | [001] 12 5.9 × 5.9* | | |

10-Ring Structures

| AEL | AlPO-11 | [001] 10 4.0 × 6.5* | | |
|---|---|---|---|---|
| AFO | AlPO-41 | [001] 10 4.3 × 7.0* | | |
| AHT | AlPO-H2 | [001] 10 3.3 × 6.8* | | |
| CGF | Co—Ga-Phosphate-5 | {[100] 10 2.5 × 9.2* + 8 2.1 × 6.7*} | | [001] 8 2.4 × 4.8* |
| CGS | Co—Ga-Phosphate-6 | {[001] 10 3.5 × 8.1 | [100] 8 2.5 × 4.6}*** | |
| DAC | Dachiardite | [010] 10 3.4 × 5.3* | [001] 8 3.7 × 4.8* | |
| EPI | Epistilbite | [100] 10 3.4 × 5.6* | [001] 8 3.7 × 4.5* | |
| EUO | EU-1 | [100] 10 4.1 × 5.4* | | |
| FER | Ferrierite | [001] 10 4.2 × 5.4* | [010] 8 3.5 × 4.8* | |
| HEU | Heulandite | {[001] 10 3.1 × 7.5* + 8 3.6 × 4.6*} | | [100] 8 2.8 × 4.7* |
| LAU | Laumontite | [100] 10 4.0 × 5.3* | | |
| MEL | ZSM-11 | <100> 10 5.3 × 5.4*** | | |
| MFI | ZSM-5 | {[100] 10 5.1 × 5.5 | [010] 10 5.3 × 5.6}*** | |
| MFS | ZSM-57 | [100] 10 5.1 × 5.4* | [010] 8 3.3 × 4.8* | |
| MTT | ZSM-23 | [001] 10 4.5 × 5.2* | | |
| MWW | MCM-22 | [001] 10 4.0 × 5.5** \| | [001] 10 4.1 × 5.1** | |
| NES | NU-87 | [100] 10 4.8 × 5.7** | | |
| -PAR | Partheite | [001] 10 3.5 × 6.9* | | |
| SFF | SSZ-44 | [001] 10 5.4 × 5.7* | | |
| STF | SSZ-35 | [001] 10 5.4 × 5.7* | | |

8-Ring Structures (cont.)

| CAS | Cesium Aluminosilicate | [001] 8 2.4 × 4.7* | | |
|---|---|---|---|---|
| CHA | Chabazite | [001] 8 3.8 × 3.8*** | | |
| DDR | Deca-dodecasil 3R | [001] 8 3.6 × 4.4** | | |
| DFT | DAF-2 | [001] 8 4.1 × 4.1* | [100] 8 1.8 × 4.7* | [010] 8 1.8 × 4.7* |
| EAB | TMA-E | [001] 8 3.7 × 5.1** | | |
| EDI | Edingtonite | <110> 8 2.8 × 3.8** | [001] 8 2.0 × 3.1* | |
| ERI | Erionite | [001] 8 3.6 × 5.1*** | | |
| ESV | ERS-7 | [010] 8 3.5 × 4.7* | | |
| GIS | Gismondine | {[100] 8 3.1 × 4.5 | [010] 8 2.8 × 4.8}*** | |
| GOO | Goosecreekite | [100] 8 2.8 × 4.0* | [010] 8 2.7 × 4.1* | [001] 8 2.9 × 4.7* |
| ITE | ITQ-3 | [010] 8 3.8 × 4.3* | [001] 8 2.7 × 5.8* | |
| JBW | NaJ | [001] 8 3.7 × 4.8* | | |
| KFI | ZK-5 | <100> 8 3.9 × 3.9*** \| | <100> 8 3.9 × 3.9*** | |
| LEV | Levyne | [001] 8 3.6 × 4.8** | | |
| LTA | Linde Type A | <100> 8 4.1 × 4.1*** | | |
| MER | Merlinoite | [100] 8 3.1 × 3.5* | [010] 8 2.7 × 3.6* | |
| | | [001] {8 3.4 × 5.1 + 8 3.3 × 3.3*} | | |
| MON | Montesommaite | [100] 8 3.2 × 4.4* | [001] 8 3.6 × 3.6* | |
| MTF | MCM-35 | [001] 8 3.6 × 3.9* | | |
| PAU | Paulingite | <100> 8 3.6 × 3.6*** \| | <100> 8 3.6 × 3.6*** | |
| PHI | Phillipsite | [100] 8 3.8 × 3.8* | [010] 8 3.0 × 4.3* | [001] 8 3.2 × 3.3* |
| RHO | Rho | <100> 8 3.6 × 3.6*** \| | <100> 8 3.6 × 3.6*** | |
| RTE | RUB-3 | [001] 8 3.7 × 4.4* | | |
| RTH | RUB-13 | [100] 8 3.8 × 4.1* | [001] 8 2.5 × 5.6* | |
| SAS | STA-6 | [001] 8 4.2 × 4.2* | | |
| SAT | STA-2 | [001] 3.0 × 5.5*** | | |
| SAV | Mg-STA-7 | <100> 8 3.8 × 3.8** | [001] 8 3.9 × 3.9* | |
| THO | Thomsonite | [100] 8 2.3 × 3.9* | [010] 8 2.2 × 4.0* | [001] 8 2.2 × 3.0* |
| TSC | Tschörtnerite | <100> 8 4.2 × 4.2*** | <110> 8 3.1 × 5.6*** | |
| VNI | VPI-9 | {<110> 8 3.1 × 4.0 | [001] 8 3.5 × 3.6}*** | |
| YUG | Yugawaralite | [100] 8 2.8 × 3.6* | [001] 8 3.1 × 5.0* | |
| ZON | ZAPO-M1 | [100] 8 2.5 × 5.1* | [010] 8 3.7 × 4.4* | |

### REFERENCES

[1] L. S. Cheng and S. T. Wilson, U.S. Pat. No. 6,293,999.
[2] M. Tanaka and S. Sugiyama, U.S. Pat. No. 5,851,381.
[3] T. Tsutsui, T. Sasaki, Y. Satou, O. Kubota, S. Okada and M. Fujii, U.S. Pat. No. 6,204,422.
[4] H. Hachisuka, K. Ikeda and K. Inoue, U.S. Pat. No. 5,709,733.
[5] D. A. LaMonica, U.S. Pat. No. 5,545,329.
[6] J. Yao, J. J. Chen, R-J. Lee and D. G. Elliot, U.S. Pat. No. 6,116,050.
[7] E. Barbera-Guillem and M. O. Thurston, U.S. Pat. No. 6,126,835.
[8] F. Fuentes, P-O. Delle, A. Willemot, L. Barry, F. Fillet, and J-L. Gelot, U.S. Pat. No. 5,538,536.
[9] K. F. Butwell, W. B. Dolan and S. M. Kuznicki, U.S. Pat. No. 6,315,817.
[10] R. D. Rothchild, U.S. Pat. No. 5,672,197.
[11] M. J. Mitariten, U.S. Pat. No. 5,245,099.
[12] W. G. O'Brian, C. J. Noelke, R. C. Harker, D. J. van Bramer, U.S. Pat. No. 6,123,749.
[13] W. G. O'Brian and B. A. Mahler, U.S. Pat. No. 5,858,066.
[14] K. H. Lee, U.S. Pat. No. 5,456,841.
[15] R. W. Baker, K. A. Lokhandwala, D. Gottschlich and M. L. Jacobs, U.S. Pat. No. 5,755,855.
[16] A. Shimazu, T. Matshusita, T. Miyazaki and K. Ikeda, U.S. Pat. No. 6,252,038.
[17] G. Paret and R. Paludeto, U.S. Pat. No. 5,510,562.
[18] P. Boucot, J-A. Chodorge, A. Forestiere, Y. Glaize and F. Hughes, U.S. Pat. No. 5,853,551.
[19] I. Sucholeiki, U.S. Pat. No. 6,277,332.
[20] J. D. Seader and E. J. Henley, Separation Process Principles, (John Wiley, New York, 1998).
[21] S. Yashonath and P. Santikary, J. Phys. Chem., 98, 6368 (1994).
[22] R. Landauer, Phys. Rev. A. 12, 636-638 (1975).
[23] S. Bandyopadhyay and S. Yashonath, J. Phys. Chem., 99, 4286 (1995).
[24] R. Chitra and S. Yashonath, J. Chem. Phys., 110, 5960 (1999).
[25] R. Chitra and S. Yashonath, Faraday Discuss., 106, 105 (1997).
[26] A. V. Anil Kumar and S. Yashonath, J. Phys. Chem., B 104, 9126 (2000).
[27] M. Bekele, S. Rajesh, G. Ananthakrishna, N. Kumar, Phys, Rev. E. B59, 143-149 (1999).
[28] A. V. Anil Kumar, S. Yashonath and G. Ananthkrishna, Phs. Rev. Lett., 88, 20601 (2002).
[29] J. J. Pluth and J. V. Smith, J. Am. Chem. Soc., 102, 4704 (1980).
[30] N. Metropolis, A. W. Rosenbluth, M. N. Rosenbluth, A. H. Teller and E. Teller, J. Chem. Phys., 21, 1087 1953).
[31] M. P. Allen and D. J. Tildesley, Computer Simulation of Liquids, (Clarendon Press, Oxford, 1987).
[32] R. Chitra and S. Yashonath, Mol. Phys., 98, 657 (2000).
[33] R. M. Barrer, Zeolites and Clay Minerals as Sorbents and Molecular Sieves (Academic Press, London, 1978).
[34] V. Thangadurai, A. K. Shukla and J. Gopalalkrishnan, J. Mater. Chem., 9, 739 (1999).
[35] G. Ananthakrishna, A. V. Anil Kumar, and S. Yashonath, Indian Patent Application no. 1006/MAS/2001 dated Dec. 18, 2001.
[36] C. Blanco and S. M. Auerbach, J. Am. Chem. Soc. (Communication), vol. 124, p. 6250 (2002).
[37] F. Jiménez-Cruz and G. C. Laredo, Fuel, Vol. 83, p. 2189 (2004).
[38] Ch. Baerlocher, W. M. Meier and D. H. Olson, 5th edition, Elsevier (2001).
[39] W. L. Jorgensen, J. D. Madura, C. J. Swenson, J. Am. Chem. Soc., Vol. 106, p. 6638 (1984).

We claim:

1. An improved method for the separation of mixtures of atomic, molecular, or ionic species of differing dimensions, said method comprising the steps of passing the mixture through a column of a predetermined porous solid and simultaneously subjecting the mixture to the combined influence of “levitation” and “blow-torch” effects.

2. The method as claimed in claim 1, wherein the mixture comprises various gases and vapours including, but not limited to, hydrocarbons, inert gases, hydrides, sulphides, and halides.

3. The method as claimed in claim 1, wherein the mixture is a binary mixture selected from a group comprising hydrocarbon gases, biological substances, ionic solutions, proteins, or combinations thereof.

4. The method as claimed in claim 1, wherein the porous solid is selected so that one of the components of the binary mixture lies in the anomalous regime and the other in linear regime of diffusion through the porous solid, as defined by the value of γ, the levitation parameter.

5. The method as claimed in claim 1, wherein the component of the binary mixture with γ closer to unity is lying in the anomalous regime is driven to one extreme of the separation column, and the other component with γ farther from, and significantly less than unity, lying in the linear regime is driven to the opposite extreme of the separation column.

6. The method as claimed in claim 1, wherein the blow-torch effect is realized through the creation of hot spots at periodic locations in the predetermined porous solid.

7. The method as claimed in claim 1, wherein the porous solid is a natural or a synthetic zeolite.

8. The method as claimed in claim 6, wherein the hot spots are created (a) by attaching appropriate chemical groups at the desired periodic locations of the porous solid and (b) by the subsequent irradiation of the porous solid with electromagnetic radiation of a chosen range of wavelengths to induce resonant absorption of energy by the chemical groups so attached.

9. The method as in claim 8, wherein the hot spots are induced in porous solids at periodic locations along the direction in which the separation is to be achieved.

10. The method as claimed in claim 8, wherein the electromagnetic radiation is preferably an infrared beam of frequency about 1600 cm⁻¹, which excites vibrational modes of the chemical group C═CH₂.

11. The method as claimed in claim 8, wherein said chemical groups possessing a dipole moment, such as, but not limited to, —OH, —CN, —CF, —C═CH₂, are bonded to the pore structure of the porous solid.

12. The method as claimed in claims 11, wherein the said chemical groups possessing a dipole moment, such as —OH, —CN, —CF, are bonded to the framework of a zeolite between cage centre and window at a distance ranging from 1 Å to 2 Å away from the plane of window.

13. The method as claimed in claim 1, wherein the length of the column of the porous solid ranges from a few nanometers to a few millimeters.

14. The method as claimed in claim 1, wherein the column length of the porous solid is chosen to yield the degree of separation desired.

15. The method as claimed in claim 1, wherein the mixtures of more than two components are separated through multiple iterations.
